(19) United States
(12) Patent Application Publication
(10) Pub. No.: US 2003/0229551 A1
(43) Pub. Date: Dec. 11, 2003

(54) Device and method for placing or receiving order for consumables for printing device and the like and program product for making computer execute the method

(76) Inventor: Fumiaki Kobayashi, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/413,527

(22) Filed: Apr. 15, 2003

(30) Foreign Application Priority Data
Apr. 15, 2002 (JP) 2002-111518

(51) Int. Cl. G06F 17/60

(52) U.S. Cl. 705/28

(57) ABSTRACT

A facsimile device for placing an order at ease at a suitable timing prior to the depletion of consumables of facsimile device, includes a BACKUPRAM which previously stores a telephone number to identify a receiver of an order of consumables, a detecting sensor which detects a remaining quantity of the consumables, a reading portion which, when the detecting sensor detects the remaining quantity below a predetermined level, reads out a telephone number from BACKUPRAM, a calling portion which makes a call to the telephone number via a telephone line in response to the reading of the telephone number, and a receiving portion which receives order form data from an ordering center via the telephone line for placing an order for consumables.

### BACKGROUND OF THE INVENTION

1. Field of the Invention

The present invention relates to a consumables ordering device, a consumables ordering method and a consumables ordering program product for placing an order for consumables for a printing device and the like. Further, the present invention relates to a consumables order receiving device, a consumables order receiving method and a consumables order receiving program product for receiving an order for consumables, which order being placed by the device.

2. Description of the Background Art

Facsimile machines, copiers and printers with facsimile function have conventionally been known. These devices are provided with printers for printing out on recording medium image information received via a telephone line by facsimile function. For the printers, consumables including recording medium and ink which is used for printing on recording medium are employed. A sensor for detecting the remaining quantity of the consumables is provided, and when the remaining quantity falls below a predetermined level, message prompting the replenishment is displayed on a display panel provided on an upper surface of the device.

User, noticing the message displayed on the display panel, replenishes the consumables. When the consumables to be used has not been prepared, the user have to place an order for the consumables. An ordering work is accomplished by a person in charge of ordering, who formulates a purchase order and sends an order form to a certain dealer.

Thus, as the work of ordering consumables is done by the person in charge, the timing of the ordering is left to the discretion of the person. Hence, the ordering is sometimes not performed at a suitable timing.

Japanese Patent Laying-Open No. 10-309851 discloses a technique for receiving an order form for consumables via an electronic mail from a server connected to a network when a remaining quantity of the consumables falls below a certain level. According to the technique disclosed in Japanese Patent Laying-Open No. 10-309851, the communication with the server is performed via a network. In particular, the order form is received as an electronic mail. Therefore, in addition to a normal facsimile function, a network communication function must be added. The addition of such function also creates the problem of the cost rise of the device.

### SUMMARY OF THE INVENTION

The present invention is provided to solve the problem as described above and an object of the present invention is to provide a consumables ordering device, a consumables ordering method and a consumables ordering program allowing an easy ordering at suitable timing prior to the depletion of the consumables and a computer readable storage medium storing the consumables ordering program.

Another object of the present invention is to provide a consumables order receiving device, a consumables order receiving method and a consumables order receiving program allowing an offer of information corresponding to a caller and a computer readable storage medium storing the consumables order receiving program.

Still another object of the present invention is to provide a consumables order receiving device, a consumables order receiving method and a consumables order receiving program allowing an easy execution of an order receiving process and a computer readable storage medium storing the consumables order receiving program.

According to one aspect of the present invention to achieve the objects described above, a consumables ordering device for placing an order for consumables includes: a storage unit to previously store a particular number for identifying a receiver of the order of the consumables; a detecting portion to detect a remaining quantity of the consumables; a reading portion to read the particular number from the storage unit when the detecting portion detects that the remaining quantity is below a predetermined level; a calling portion to call the particular number via a telephone line in response to the reading of the particular number; and a receiving portion to receive order form data via a telephone line for placing an order for the consumables from the receiver.

According to the present invention, when it is detected that the remaining quantity is below a predetermined level, a call is made to a specific number via a telephone line and order form data for placing an order for the consumables is received from the orderer. Thus, a consumables ordering device can be provided for allowing an easy ordering at a suitable timing prior to the depletion of the consumables as the order form is received via a telephone line prior to the depletion of the consumables.

According to another aspect of the present invention, a consumables order receiving device for receiving an order for consumables includes: a storage unit to store a telephone number of a contractor; a caller number acquiring portion to acquire a telephone number of a caller when a call is detected via a telephone line; a determining portion to determine whether the acquired telephone number is a telephone number of a contractor stored in the storage unit or not; a setting portion to set a transmission file to be transmitted according to the result of determination by the determining portion; and a transmitting portion to transmit the set transmission file via the telephone line.

According to the present invention, when the call from the telephone line is detected, a telephone number of a caller is acquired and it is determined whether the caller is a contractor or not based on the acquired telephone number. Then, according to the result of the determination, a transmission file to be transmitted is set. Hence, it is possible to change the transmission file to be transmitted according to the determination on whether the caller is the contractor or not. As a result, a consumables ordering device can be provided allowing an offer of information corresponding to the caller.

According to still another aspect of the present invention, a consumables order receiving device for receiving an order for consumables includes: a storage unit to store a telephone number of a contractor; a caller number acquiring portion to acquire a telephone number of a caller when a call is detected via a telephone line; a contractor information extracting portion to extract information of a contractor stored in the storage unit based on the acquired telephone number; a receiving portion to receive order form data carrying order information; a reading portion to read order information from the received order form data; an order information storage unit to store the extracted contractor information and the read order information correspondingly; and a transmitting portion to transmit a receipt via the telephone line.

According to the present invention, when a call from the telephone line is detected, a telephone number of the caller is acquired and information of contractor is extracted based on the acquired telephone number. Then, order form data carrying order information is received and order information read from the order form data and the contractor information are stored corresponding with each other and receipt data is transmitted via the telephone line. Thus, only with the reception of order form data via the telephone line an orderer and order information can be identified. As a result, a consumables order receiving device can be provided allowing an easy execution of order receiving process.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a facsimile device of one embodiment of the present invention.

FIG. 2 is a block diagram showing a structure of a consumables order receiving device of one embodiment of the present invention.

FIG. 3 is a flow chart showing a process flow of a consumables ordering process performed in a facsimile device of the embodiment.

FIGS. 4A and 4B are diagrams showing a process flow of a script transmission process performed in a consumables order receiving device of the embodiment.

FIG. 5 is a drawing showing an example of an order form to be transmitted from a consumables order receiving device of the embodiment; and

FIGS. 6A and 6B are diagrams for explaining an order receiving process performed in a consumables order receiving device of the embodiment.

### DESCRIPTION OF THE PREFERRED EMBODIMENTS

Hereinafter the embodiments of the present invention will be described with reference to the drawings. In the following description, same parts and components are indicated by the same character. They have same name and function. Hence, detailed description thereof will not be repeated.

As an example of a consumables ordering system, a system including a facsimile device and a consumables order receiving device will be described as an embodiment.

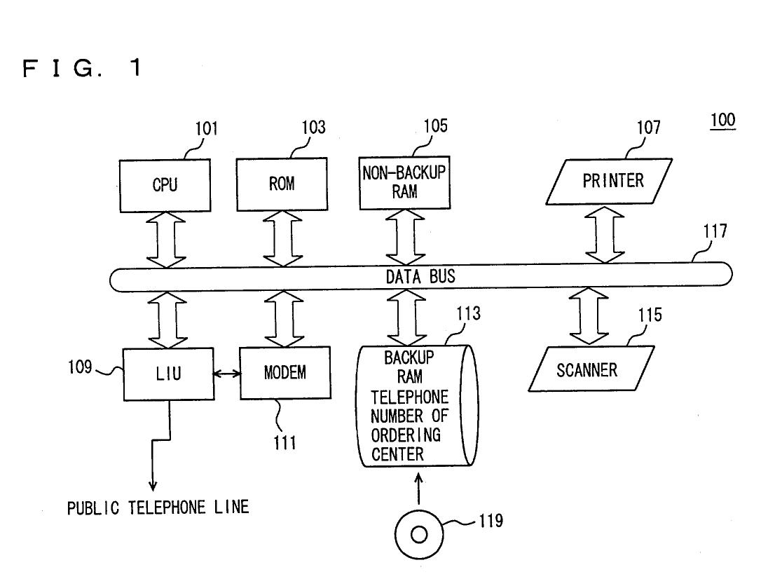

FIG. 1 shows a structure of a facsimile device of one embodiment of the present invention in a block diagram form. As is shown in FIG. 1, a facsimile device 100 includes, a Central Processing Unit (CPU) 101, an Read Only Memory (ROM) storing programs such as a boot up program of an operating system, a Non-backup Random Access Memory (NON-BACKUPRAM) 105 for loading a program to be executed and for storing data during program execution, BACKUP Random Access Memory (BACKUP RAM) 113 for storing a telephone number of an ordering center, modem (MODEM) 111 for producing and receiving a signal for a facsimile communication, a Line Interface Unit (LIU) 109 for transmitting and receiving a signal according to a line standard of facsimile, telephone, and the like, a printer 107 and a scanner 115, each connected to a bus 117.

BACKUPRAM 113 is a magnetic disk device such as a hard disk. BACKUPRAM 113 can read and store a program stored in a storage medium 119. A program stored in BACKUPRAM 113 is executed by CPU 101.

Thus, facsimile device 100 is implemented with a hardware and a software executed by CPU 101. Generally such software is stored in storage medium 119 such as a CD-ROM and read out from the storage medium and temporarily stored in BACKUPRAM 113. Subsequently, the software is read out from BACKUPRAM 113 to NON-BACKUPRAM 105 and executed by a CPU 121. The hardware itself of facsimile device 100 as shown in FIG. 1 is an ordinary one. Hence, the most essential element of the present invention is software stored in a storage medium such as CD-ROM 119 and BACKUPRAM 113.

The printer prints out an image received by LIU 109, an image read by scanner 115, and an image stored in BACKUPRAM 113 or NON-BACKUPRAM 105. Printer 107 is a thermal transfer printer.

Scanner 115 reads a script to be transmitted to other facsimile devices and the like via LIU 109 and a script to be printed out at printer 107 and outputs image data.

In facsimile device 100, recording paper and ink film are used as consumables. In this example, printer 107 of facsimile device 100 is assumed to be a thermal transfer printer, however, other types of printers can be used. When other types of printers are used as printer 107, an ink cartridge is used as consumables for an ink jet printer and photoconductor drums and toners are used as consumables for a laser printer. Thus the types of consumables may be changed according to the type of printer to be used, product names of the consumables for each type of printers are previously stored in ROM 103 or BACKUPRAM 113.

In addition, facsimile device 100 has, as a sensor for detecting the degree of depletion of the consumables, a sensor for detecting an amount of transfer of an ink film to detect the remaining quantity of ink film. The amount of transfer of the ink film at the latest printing is added to the accumulated amount of transfer thereby producing the total accumulated amount of transfer and the remaining quantity of the ink film is calculated. When printer 107 is an ink jet printer, a sensor is provided for optically reading the remaining quantity of ink in the ink cartridge. When printer 107 is a laser printer, a sensor is provided for detecting a running time of a charger for electrifying a photoconductive drum and a sensor is provided for optically reading the remaining quantity of the toner.

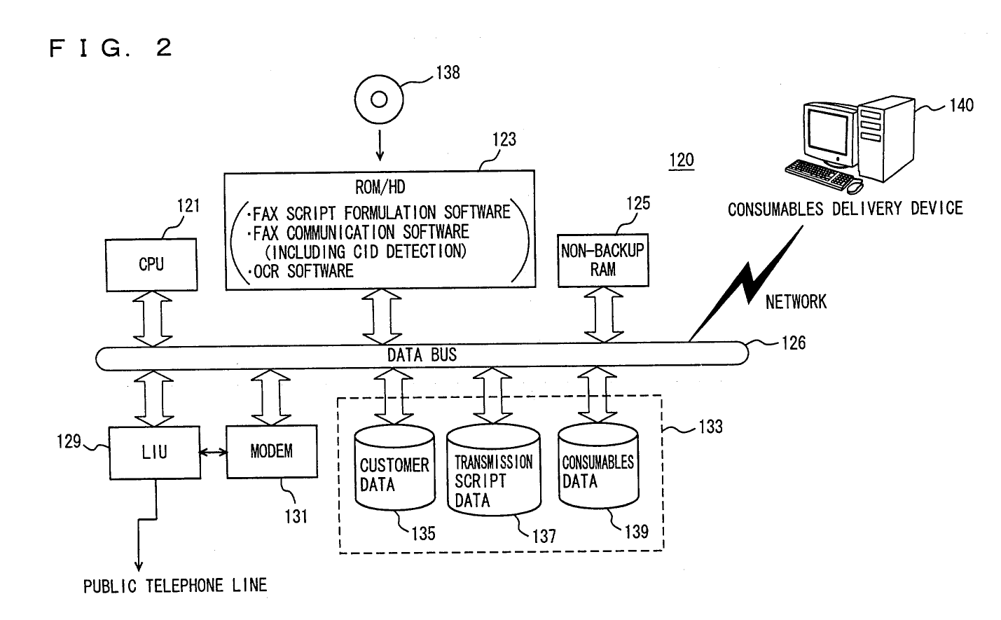

FIG. 2 shows a structure of a consumables order receiving device according to one embodiment of the present invention in a block diagram form. As shown in FIG. 2, a consumables order receiving device 120 includes a CPU 121, a Read Only Memory/Hard Disk (ROM/HD) 123 storing a program such as boot up program of an operating system, a NON-BACKUPRAM 125 for loading a program to be executed and for storing data during program execution, a BACKUPRAM 133 for storing customer data 135, transmission script data 137 and consumables data 139, a modem (MODEM) 131 for producing and receiving a signal for facsimile communication and an LIU 129 for transmitting and receiving a signal according to a line standard of facsimile, telephone or the like, each connected to a bus 126.

In ROM/HD 123, a software is stored, including a facsimile communication software to allow the communication with a facsimile device, an Optical Character Recognition (OCR) software for recognizing a handwritten character displayed as an image and transforming the same into a character code, a document formulation software and a network communication software.

Consumables order receiving device 120 is implemented with a computer hardware and a software executed by CPU 121. In general, such software is stored in a storage medium such as a CD-ROM 138 and distributed and read out from the storage medium and temporarily stored in ROM/HD 123. Further, the software is read out from ROM/HD to RAM 125 and executed by CPU 121. The hardware itself of the consumables order receiving device as shown in FIG. 2 is an ordinarily one. Hence, the most essential part of the present invention is a software stored in storage medium such as CD-ROM 138 and ROM/HD 123.

As an operation of the facsimile device itself as shown in FIG. 1 and an operation of the computer itself as shown in FIG. 2 are known, the detailed description thereof will not be repeated here.

Software means a program in a source program format, compressed program and encrypted program in addition to programs directly executable by CPUs 101 and 121.

The storage medium storing such software may be a magnetic tape, a cassette tape, an optical disk, an IC card (including a memory card), an optical card, and a semiconductor memory such as a mask ROM, an erasable programmable read only memory (EPROM), an electrically erasable programmable ROM (EEPROM) and a flash memory which statistically store the program, other than CD-ROM 119 and 138.

With reference to FIG. 2, consumables order receiving device 120 is connected to a consumables delivery device 140. In this embodiment, at an ordering center, consumables order receiving device 120 and the consumables delivery device are installed. These, together with facsimile device 100 constitute an ordering system. In the ordering system, order information sent from facsimile device 100 is received by consumables order receiving device 120 and order receiving information is created at the consumables order receiving device based on the received order information and sent to the consumables delivery device. Consumables delivery device 140 performs information processing for the delivery based on the received order receiving information.

For this purpose, BACKUPRAM 133 of consumables order receiving device 120 stores customer data 135, transmission script data 137 and consumables data 139. As customer data, identification information for identifying a customer (customer number), a telephone number of a public telephone line connected to facsimile device 100 of the customer, a product name (a model number) of consumables of facsimile device 100 of the customer, an account number of a bank for the payment of a bill of the consumables, and a discount rate are stored corresponding to each other.

As to the product name (model number) of the consumables of facsimile device 100 of the customer, when facsimile device 100 has, as consumables, an ink film and recording paper of A4 size, for example, the product name of the ink film and the products name of A4 recording paper are stored as the customer data corresponding to the telephone number.

The discount rate is determined according to the frequency of the purchase and the amount of the purchase. Thus, customer who purchases frequently by a large amount will be given an advantage compared with customers who do not purchase frequently by a large amount. Further, when a membership system is adapted, an item to distinguish a cost for member and a cost for non-member is provided in the customer data and the cost for member and the cost for non-member are provided in the consumables data thereby differentiating the cost of consumables based on the memberships data.

A customer who is regarded as an object of storage in the customer data is a customer registered in the ordering system. As described later, registration at the ordering system can be completed through a predetermined registration procedure. The registration procedure can be preformed through the registration of information including a telephone number of a public telephone line connected to facsimile device 100 of the customer and information for the bill payment of the consumables, for example an account number of a bank for the payment. Here, it is possible to use other ways of payment such as a payment by a credit card and a payment on delivery system where a carrier will collect the bill when the customer receives the ordered goods, and the way of payment is not limited to payment by a bank account.

Here, when the registration to the ordering system is completed, the telephone number of the public telephone line connected to consumables order receiving device 120 of the ordering center is stored into BACKUPRAM 113 of facsimile device 100 by the customer.

Transmission script data 137 is data of a script to be transmitted to facsimile device 100. In this embodiment, script data of an order form for placing an order for the consumables and script data of an application form for registering to the ordering system are stored.

As consumables data 139, a product name (a model number) and a cost of consumables are stored corresponding to each other. Hence, when the cost of the consumables is changed, necessary change to data is a change of consumable data 139 alone.

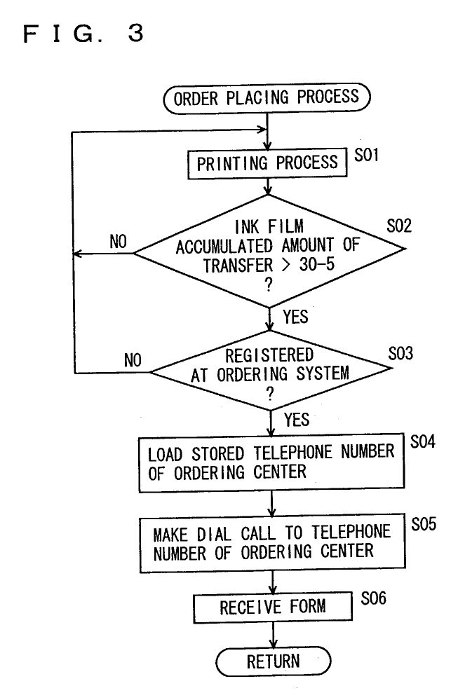

FIG. 3 is a flow chart showing a process flow of consumables ordering process performed in facsimile device 100 of the embodiment. With reference to FIG. 3, when a printing process is performed at printer 107 of facsimile device 100 (step S01), the amount of transfer of the ink film is detected and the detected amount of transfer is added to an accumulated value of the amount of transfer stored in BACKUPRAM 113. Then, it is determined whether the accumulated value of the amount of the transfer thus acquired exceeds a predetermined value or not (step S02).

Here, the predetermined value is a value sought by extracting the remaining amount of ink film at the time of ordering of the ink film from the usable amount of the ink film. Here, the usable amount of ink film is assumed to be 30 m, and the remaining amount of the ink film at the time of ordering of the ink film is assumed to be 5 m. In other words, at this step, it is determined whether the accumulated value of the amount of the transfer of the ink film exceeds 25 m or not. This is equal to determine whether the remaining amount of the ink film falls below 5 m or not.

When the accumulated value of the amount of transfer of the ink film exceeds the predetermined value, the process goes to step S03 and if the value is equal to or below the predetermined value the process goes back to step S01.

At step S03, it is determined whether the registration at the ordering system has been completed or not. The determination on the completion of the registration at the ordering system is performed based on the storage in BACKUPRAM 113 of the telephone number of consumables order receiving device 120 which is installed in the ordering center and is connected to the public telephone line. As described above, when the customer registers at the ordering system, the telephone number of the ordering center is stored in BACKUPRAM 113 by the customer. Therefore, when the telephone number of the ordering center is stored in BACKUPRAM 113, the process goes to step S04 and if the telephone number of the ordering center is not stored in BACKUPRAM 113, the process goes back to step S01.

In this embodiment, the telephone number of the ordering center is stored in BACKUPRAM 113 at the registration at the ordering system, however, the telephone number of the ordering center may be stored in BACKUPRAM 113 at the time of shipment of facsimile device 100. In this case the process step of step S03 may not be performed. Hence, when the accumulated value of the amount of transfer of the ink film exceeds the predetermined value at step S02, regardless of the completion of the registration to the ordering system, the process goes to step S04.

Then, the telephone number of the ordering center stored in BACKUPRAM 113 is read (step S04) and a call is made to consumables order receiving device 120 via the public telephone line from LIU 109 (step S05).

When the connection to consumables order receiving device 120 is made, according to the polling protocol, the order form or the application form is received (step S06). The received order form or the received application form is printed out from printer 107.

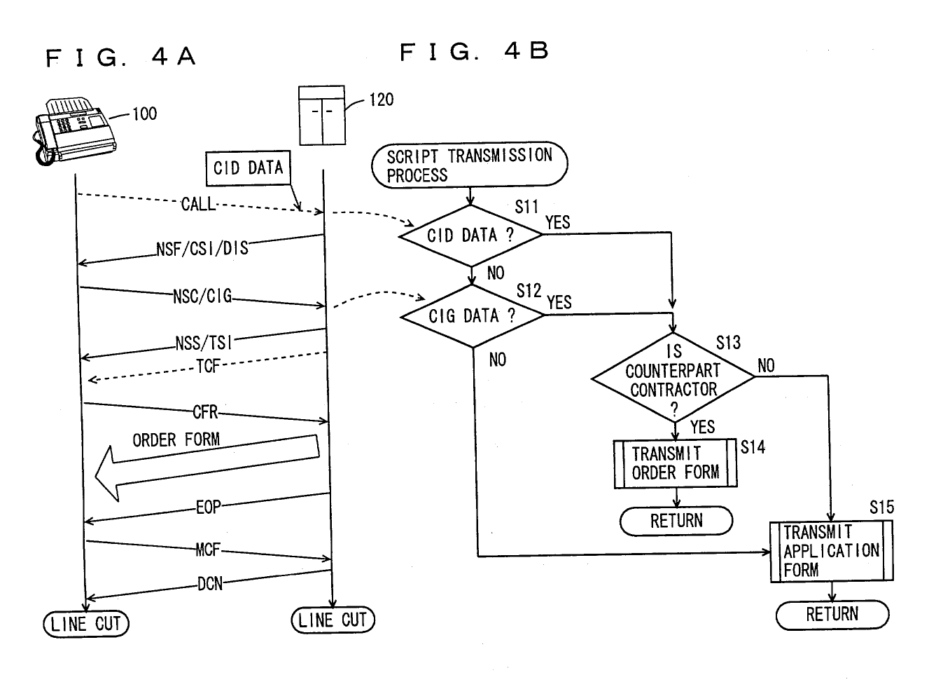

FIGS. 4A and 4B are drawings showing the process flow of a script transmission process performed in consumables order receiving device 120 of the embodiment. FIG. 4A shows an example of control signals transmitted between facsimile device 100 and consumables order receiving device 120, and FIG. 4B is a flow chart showing a process flow of the script transmission process performed in consumables order receiving device 120. Control signals are 300 bps frequency shift keying (FSK) signal according to the G3 facsimile protocol defined in ITU-T T30.

With reference to FIGS. 4A and 4B, consumables order receiving device 120 determines whether a caller number notice (CID: Caller ID) is received from a telephone switchboard in response to the call from facsimile device 100 or not (step S11). If CID is received, the telephone number of the caller is acquired and the process goes to step S13 and if CID is not received the process goes to step S12.

At step S12, the line is connected in a same manner as in an ordinary calling of the facsimile device and signals NSF/CSI/DIS are transmitted. Signal NSF is a signal used by a receiving terminal (consumables order receiving device 120) to show the specification of itself and has an original format of the maker. Signal DIS is a signal used by the receiving terminal (consumables order receiving device 120) to show the specification of itself and has a common format. Signal CSI is a telephone number of a public telephone line connected to the receiving terminal (consumables order receiving device 120). In response to the signals, signals requesting the polling (NSC/CIG) from facsimile device 100 are received. Signal NSC is a signal to indicate the request of polling by the caller and has an original format of the maker. Signal CIG is a telephone number of the public telephone line connected to a terminal (facsimile device 100) requesting a polling process.

At step S12, it is determined whether CIG data is received or not and if the CIG data is received, the telephone number of facsimile device 100 is acquired and the process goes to step S13 and if CIG data is not received the process goes to step S15.

Consumables order receiving device 120, as a transmitter, sends signals NSS/TSI and performs a training with signal TCF. Signal NSS is a signal to indicate transmission specification of data and has an original format of the maker. Signal TSI is a telephone number of the public telephone line connected to transmitting terminal (consumables order receiving device 120). Signal TCF is a signal to check whether image transmission is possible at a certain transmission speed. Facsimile device 100 checks the signal TCF and if the result of the training shows a good condition, returns signal CFR and turns into a condition that allows the reception of an image.

Consumables order receiving device 120 receives signal CFR. Then, consumables order receiving device 120 turns into a condition capable of transmitting an image to facsimile device 100. Signal CFR is a signal to indicate the result of the training check with TCF and indicates that the image transmission is possible at the transmission speed.

At step S13, it is determined whether the user of facsimile device 100 is a registrant (contractor) of the ordering system or not. This determination is performed through the comparison between the telephone number of facsimile device 100 acquired in step S11 or step S12 and customer data stored in customer data 135 of BACKUPRAM 133. If the customer data stored in customer data 135 of BACKUPRAM 133 has a telephone number which matches with the telephone number of facsimile device 100 acquired in step S11 or step S12, the user is determined to be a contractor and if there is no match, the user is determined to be a non-contractor (step S13). When the user is determined to be a contractor, the process goes to step S14, whereas if the user is determined to be non-contractor, the line may be disconnected.

In step S14, script data of an order form stored as transmission script data in BACKUPRAM 133 is read out and affixed with necessary customer data and consumables data and send to facsimile device 100.

Here, the cost of consumables is added to the transmission script which shows the cost after the discount based on the discount rate in the customer data. Thus, the customer who purchases frequently by a large amount can enjoy an advantage compared with the customers who do not purchase frequently by a large amount. Further, when the membership system is adapted, from the item classifying the customer into member and non-member in the customer data, information on the membership of the customer can be obtained and the cost for the member or the cost for non-member are read out from the customer data and added.

Further, when the model name of the facsimile of the customer, the purpose of the use of the facsimile, for example, for home use or for the office use, and names of makers of office appliances other than the facsimile can be stored as customer data, information on new product, special bargain sale of the office appliances including the facsimile device and the like can be extracted on the customer basis based on this information and added to the script data of the order form. Thus, different advertisement information can be added to the order form or the application form on the customer basis.

At step S15, script data of the application form stored as application script data in BACKUPRAM 133 is transmitted to facsimile device 100.

Facsimile device 100 prints out the received order form or the received application form.

On completing the transmission of data of one page, consumables order receiving device 120 transmits a signal EOP to indicate that the page which has just been sent is the last. Signal EOP is a signal to indicate the completion of one page image transmission and the fact that the image which has been sent is the last page. If the script is received in a good condition, facsimile device 100 returns a signal MCF. Signal MCF (message confirmation) is a signal to indicate that the received page is in a good condition. On conforming signal MCF, consumables order receiving device 120 transmits a signal DCN. Then, facsimile device 100 and consumables order receiving device 120 both cut the line. Signal DCN (disconnection order) is a signal to indicate the disconnection of the line.

Thus, consumables order receiving device 120 of this embodiment determines whether the user of a facsimile device with a certain telephone number is a contractor of the ordering system or not based on the telephone number of the caller. The script data to be transmitted is made different for the contractor and for the non-contractor through the polling process. In other words, the order form is transmitted for the contractor and the application form (contract form) for the registration at the ordering system is transmitted for the non-contractor. Thus, the script to be transmitted can be changed on a caller basis, whereby appropriate information can be transmitted corresponding to the caller.

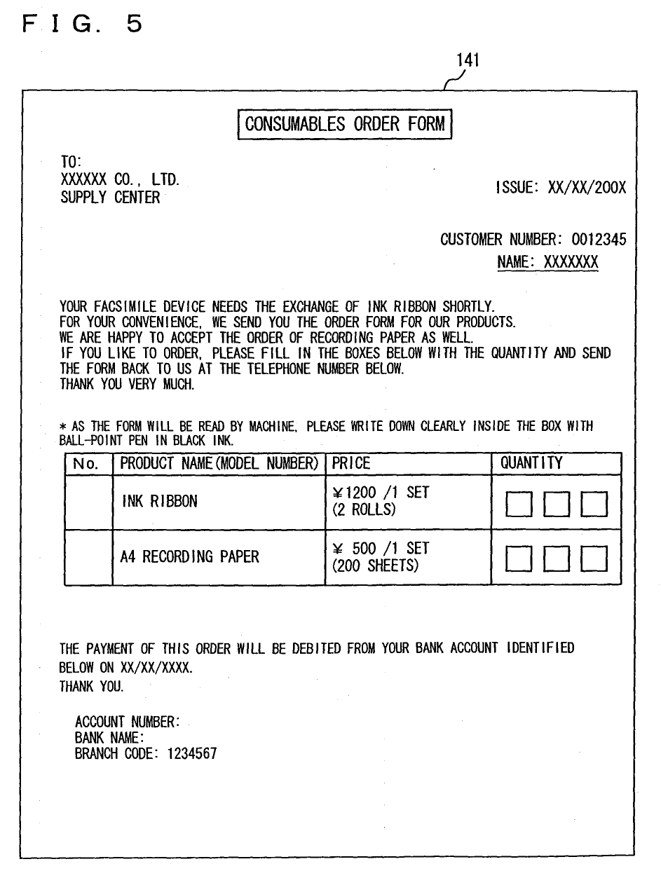

FIG. 5 is a drawing showing an example of the orders form transmitted by consumables order receiving device 120 of the embodiment. Consumables order receiving device 120 previously stores image data of the order form as shown in FIG. 5 as transmission script data in BACKUPRAM 133.

With reference to FIG. 5, order form 141 includes a customer number as an identification number to identify a customer and a name of a customer. The information is data obtained from the customer data stored corresponding to the telephone number. In the box of product name (model number) the product name of the consumables and the cost corresponding to each product name are displayed. As the consumables of facsimile device 100 is previously stored as customer data, the product name of the consumables in customer data stored corresponding to the telephone number is read out and displayed in the box.

Further, the account number of the bank for the payment stored corresponding to customer data corresponding to the telephone number is displayed. The account number also is data read out from the customer data stored corresponding to the telephone number.

Customer, noting the output of the order form from facsimile device 100, knows that the order of an ink ribbon and recording paper is necessary. Then, the customer fills the output order form with necessary quantity of the consumables and transmits the order form from facsimile device 100 to the ordering center via facsimile. Then consumables order receiving device 120 at the ordering center receives the form and the delivery is arranged.

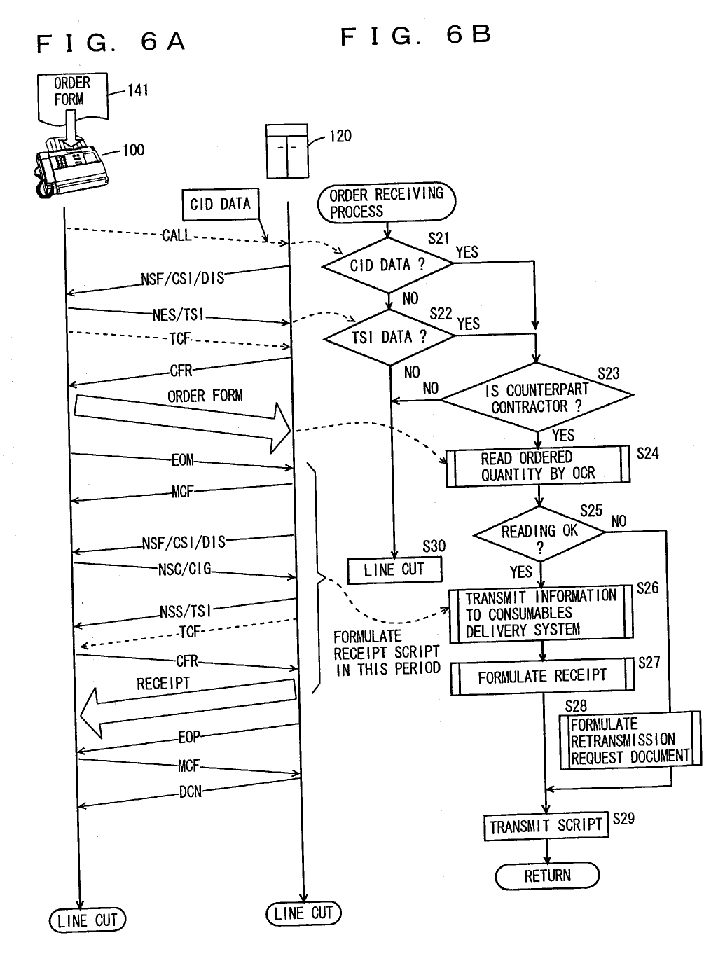

Next, an order receiving process performed in consumables order receiving device 120 will be described. FIGS. 6A and 6B are diagrams for explaining the order receiving process performed by the consumables order receiving device of the embodiment. FIG. 6A shows an example of control signals transmitted/received between facsimile device 100 and consumables order receiving device 120, FIG. 6B is a flow chart showing a process flow of the order receiving process performed in consumables order receiving device 120. With reference to FIGS. 6A and 6B, the user of facsimile device 100 fills in the order form with required quantity and transmits the same. Facsimile device 100 reads out the telephone number of the ordering center from BACKUPRAM 113 and automatically makes a dial call. Then, consumables order receiving device 120 receives a call. In response to the call from facsimile device 100, consumables order receiving device 120 determines whether CID (called number notification) is received from the telephone switchboard or not (step S21). If CID is received, the telephone number of the caller is acquired and the process goes to step S23 and if CID is not received, the process goes to step S22.

At step S22, the line is connected in a same manner as in an ordinary calling of the facsimile device and signals NSF/CSI/DIS are transmitted. Signal NSF is a signal used by a receiving terminal (consumables order receiving device 120) to show the specification of itself and has an original format of the maker. Signal DIS is a signal used by the receiving terminal (consumables order receiving device 120) to show the specification of itself and has a common format. Signal CSI is a telephone number of a public telephone line connected to the receiving terminal (consumables order receiving device 120).

Facsimile device 100 sends signals NSS/TSI and performs a training with signal TCF. Signal NSS is a signal to indicate transmission specification of data and has an original format of the maker. Signal TSI is a telephone number of the public telephone line connected to transmitting terminal (consumables order receiving device 120). Signal TCF is a signal to check whether image transmission is possible at a certain transmission speed. Consumables order receiving device 120 checks the signal TCF and if the result of the training shows a good condition, returns signal CFR and turns into a condition that allows the reception of an image.

Then, consumables order receiving device 120 compares the telephone number of the terminal identified by signal CID with a telephone number of customer data stored in BACKUPRAM 133 and determines whether it is a call from a contractor or not (step S23). If the call is determined to be from the non-contractor as the result of deteremination, consumables order receiving device 120 transmits signal DCN and cuts the line (step S30). On the other hand, if the call is determined to be from the contractor at step S23, the process goes to step S24.

Facsimile device 100, after the confirmation of the reception of signal CFR, transmits order form 141 to consumables order receiving device 120 using a high speed signal. On completing the transmission of one page data, facsimile device 100 transmits signal EOM for switching transmission/reception to consumables order receiving device 120 to allow the reception of the receipt script from the server.

If order form 141 is received in a good condition, consumables order receiving device 120 returns signal MCF to facsimile device 100 and transmits signals NSF/CSI/DIS six seconds later following the transmission switching protocol of T.30. After the reception of the order form, consumables order receiving device 120 analyzes the order form using an OCR software and extracts order content (product name and the quantity) (step S24).

Based on the result of extraction of the order content, it is determined whether the reading of OCR is successful or not (step S25). When the OCR reading is successful, the process goes to step S26, and if the reading fails, the process goes to step S28.

When the order content is extracted, order receiving information including order content and customer data (including address and telephone number) is transmitted to consumables delivery device 140 (step S26).

Facsimile device 100 transmits signals NSC/CIG to consumables order receiving device 120 for requesting the polling process of itself. Consumables order receiving device 120, as a transmitter, transmits signals NSS/TSI and performs a training with signal TCF. Facsimile device 100 checks signal TCF and if the training shows a good result, returns signal CFR and enters an image reception status.

After reading the ordered quantity at step S24, consumables order receiving device 120 formulates a receipts script (step S27). Necessary information for the formulation of the receipt can be obtained from the product name and the quantity read out at step S24 and the customer data read out in step S23.

On the other hand, step S28 shows the case where the OCR reading of the ordered quantity fails. In this case, it is assumed that noise added during the transmission of data via the public telephone line or the illegibility of the entry of the quantity to the order form is the cause of failure. In this case, a retransmission request document is formulated to request the retransmission of the order form to the user of facsimile device 100 (step S28). Document requesting retransmission can be previously formulated and stored in BACKUPRAM 133 as the retransmission request document. Further, information such as the name of the customer can be obtained from the customer data and added to the previously formulated document data for requesting the retransmission.

After the confirmation of signal CFR, consumables order receiving device 120 transmits the receipt script or the document script for retransmission request to facsimile device 100 using a high speed signal (step S29). After the completion of the transmission of one page receipt script, signal EOP indicating that transmitted data is the last page is transmitted. When facsimile device receives the script in a good condition, returns signal MCF. On confirming the reception of signal MCF, consumables order receiving device 120 transmits signal DCN. Then, facsimile device 100 and consumables order receiving device 120 both cut the line. Facsimile device 100 prints out the received receipt script or the received document script of retransmission request.

As described above, facsimile device 100 of the embodiment, when the remaining quantity of the consumables falls below a predetermined level, is connected to the consumables order receiving device of the ordering center via a telephone line, receives and outputs order form data for placing an order for consumables. Thus, the order form is printed out and output at a suitable timing prior to the depletion of consumables, whereby order of consumables can be placed at a suitable timing prior to the depletion of the consumables. Further, an unfavorable condition where the facsimile device cannot be used because of the lack of consumables until the delivery of the consumables can be avoided.

Further, it is determined whether the caller is a contractor or not based on the telephone number of the caller and transmission file to be transmitted is set according to the result of the determination. When the caller is determined to be a contractor, order form data is set as transmission file, whereas when the caller is determined to be non-contractor, form data for the conclusion of contract is set as the transmission file. Thus, information to facilitate the order process can be provided to the contractor and information for the conclusion of contract can be provided to the non-contractor. As a result, an easy ordering of the consumables as well as the promotion of the conclusion of contract with non-contractor can be achieved.

Further, consumables order receiving device 120 of the embodiment, when the order form data carrying order information is received by the facsimile, extracts the information of the contractor based on the telephone number of transmitting facsimile device 100, reads out order information from the received order form data and creates order receiving information from the contractor information and the order information. Then, receipt data is transmitted via a telephone line. Thus only by the reception of the order form data with the facsimile, the orderer and the order information can be identified.

The embodiment disclosed herein should be taken as illustration only and not limiting in any way. The scope of the invention is shown by claims and not by the description of the embodiment and includes all modifications which fall within the scope and meaning equivalent to claims.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A device for placing an order for consumables comprising:
a storage unit to previously store a particular number for identifying a receiver of the order of the consumables;
a detecting portion to detect a remaining quantity of the consumables;
a reading portion to read said particular number from said storage unit when said detecting portion detects that the remaining quantity is below a predetermined level;
a calling portion to call said particular number via a telephone line in response to the reading of said particular number; and
a receiving portion to receive order form data for placing an order for said consumables via a telephone line from said receiver.

2. The device for placing an order for consumables according to claim 1, wherein said particular number is stored in said storage unit at a time of shipment of said device.

3. A device for receiving an order for consumables comprising:
a storage unit to store a telephone number of a contractor;
a caller number acquiring portion to acquire a telephone number of a caller when a call is detected via a telephone line;
a determining portion to determine whether said acquired telephone number is a telephone number of a contractor stored in said storage unit or not;
a setting portion to set a transmission file to be transmitted according to the result of determination by said determining portion; and
a transmitting portion to transmit said set transmission file via the telephone line.

4. The device for receiving an order for consumables according to claim 3, wherein said setting portion sets order form data as the transmission file when said determining portion determines that the caller is not a contractor whereas said setting portion sets form data as the transmission file for a conclusion of a contract when said determining portion determines that the caller is a non-contractor.

5. The device for receiving an order for consumables according to claim 3, wherein
said order form data includes a cost of consumables, and
said cost of consumables is different in a case where said contractor is a particular contractor and in a case where said contractor is not a particular contractor.

6. The device for receiving an order for consumables according to claim 4, wherein
said order form data includes a cost of consumables,
the cost of consumables is a cost after a discount based on a discount rate determined by a frequency and a quantity of a purchase of consumables.

7. A device for receiving an order for consumables comprising:
a storage unit to store a telephone number of a contractor;
a caller number acquiring portion to acquire a telephone number of a caller when a call is detected via a telephone line;
a contractor information extracting portion to extract information of a contractor stored in said storage unit based on said acquired telephone number;
a receiving portion to receive order form data carrying order information;
a reading portion to read order information from said received order form data;
an order information storage unit to store said extracted contractor information and said read order information correspondingly; and
a transmitting portion to transmit a receipt via the telephone line.

8. The device for receiving an order for consumables according to claim 7, wherein said reading portion is an Optical Character Recognition (OCR).

9. The device for receiving an order for consumables according to claim 7, further comprising a transmitting portion to transmit a retransmission request file via the telephone line for requesting the retransmission when said reading portion fails to read out said order information.

10. The device for receiving an order for consumables according to claim 7, further comprising a receipt formulating portion to formulate the receipt based on said read order information.

11. A method for placing an order for consumables comprising the steps of:
previously storing a particular number for identifying a receiver of the order of the consumables;
detecting a remaining quantity of the consumables;
reading said particular number stored in said storing step when it is detected that the remaining quantity is below a predetermined level in said detecting step;
calling said particular number via a telephone line in response to the reading of said particular number; and
receiving order form data for placing an order for said consumables via a telephone line from said receiver.

12. A method for receiving an order for consumables comprising the steps of:
storing a telephone number of a contractor;
acquiring a telephone number of a caller when a call is detected by a telephone line;
determining whether said acquired telephone number is a telephone number of said stored contractor or not;
setting a transmission file to be transmitted according to the result of determination in said determining step; and
transmitting said set transmission file via the telephone line.

13. A method for receiving an order for consumables comprising the steps of:
storing a telephone number of a contractor;
acquiring a telephone number of a caller when a call is detected via a telephone line;
extracting information of said stored contractor based on said acquired telephone number;
receiving order form data carrying order information;
reading order information from said received order form data;
storing said extracted contractor information and said read order information correspondingly; and
transmitting a receipt via the telephone line.

14. A program product for placing an order for consumables making a computer execute the steps of:
previously storing a particular number for identifying a receiver of the order of the consumables;
detecting a remaining quantity of the consumables;
reading said particular number stored in said storing step when it is detected that the remaining quantity is below a predetermined level in said detecting step;
calling said particular number in response to the reading of said particular number via a telephone line; and
receiving order form data for placing an order for said consumables from said receiver.

15. A program for receiving an order for consumables, making a computer execute the steps of:
storing a telephone number of a contractor;
acquiring a telephone number of a caller when a call is detected via a telephone line;
determining whether said acquired telephone number is a telephone number of said stored contractor or not;
setting a transmission file to be transmitted according to the result of determination in said determining step; and
transmitting said set transmission file via the telephone line.

16. A program for receiving an order for consumables, making a computer execute the steps of:
storing a telephone number of a contractor;
acquiring a telephone number of a caller when a call is detected via a telephone line;
extracting information of said stored contractor based on said acquired telephone number;
receiving order form data carrying order information;
reading order information from said received order form data;
storing said extracted contractor information and said read order information correspondingly; and
transmitting receipt data via the telephone line.

17. A computer readable storage medium storing a program product for placing an order for consumables according to claim 14.

18. A computer readable storage medium storing a program product for receiving an order for consumables according to claim 15.

19. A computer readable storage medium storing a program product for receiving an order for consumables according to claim 16.
